(19) United States
(12) Patent Application Publication
(10) Pub. No.: US 2004/0166220 A1
(43) Pub. Date: Aug. 26, 2004

(54) Food and method for producing foood

(75) Inventor: Yukiko Niitsu, Hokkaido (JP)

Correspondence Address: ARENT FOX KINTNER PLOTKIN & KAHN, PLLC, Suite 600, 1050 Connecticut Avenue, N.W., Washington, DC, 20036-5339, US

(73) Assignee: Tancho-no-Mai Honpo L.t.d.

(21) Appl. No.: 10/744,068

(22) Filed: Dec. 24, 2003

(30) Foreign Application Priority Data
Dec. 27, 2002 (JP) 2002-381772
Apr. 4, 2003 (JP) 2003-101563

(51) Int. Cl. A23L 1/00

(52) U.S. Cl. 426/557

(57) ABSTRACT

Thawed snow water is utilized for producing noodles. First, the thawed snow water is added to flour after purification thereof. Then, the flour and the thawed snow water are mixed up together to make a dough. The dough can be processed into strings by cutting or stretching. The thawed snow water is also utilized for boiling raw noodles. The thawed snow water is very soft with a hardness of approximately 7.3, and has a half-width in the cluster analysis which is approximately one-half of that of usual water. The thawed snow water can improve the quality of noodles such as taste and resilience thereof. In addition, the thawed snow water may be applied to water for processing the other food such as alcoholic drinks, soy sauce, and bread.

### BACKGROUND OF THE INVENTION

1. Field of the Invention

The present invention relates to food and a method for producing the food, more specifically, to noodles and a method for producing the noodles and boiled noodles.

2. Description of the Related Art

Traditionally, raw noodles are produced by adding water to flour, mixing them up together to make a dough, rolling the dough into a sheet, and cutting the sheet into strings of noodles. Plenty of water is used for boiling the raw noodles to produce boiled noodles. Typically, tap water, natural water or salt water is used for producing the raw noodles or boiling the raw noodles. Under such a circumstance, the water quality has not been considered.

A conventional art for producing the raw noodles is disclosed in, for example, Japanese Patent Application Laid-Open No.2002-84997. The art comprises a first step of forming preservative sol; a second step of mixing up the preservative sol and flour to make a dough; a third step of rolling the dough with a loose rolling ratio to make strips of noodles; and a fourth step of cutting the strip into strings of noodles. In the second step, the preservative sol has a certain moisture content, in which the water addition ratio to wheat flour reaches 50-65%.

The above art increases the moisture content of the noodles, thereby stabilizing the quality of the noodles, reducing the boiling time of the noodles, and enabling the production of the noodles with sufficient resilience. However, the type or quality of water to be added to the flour has not been considered.

As for various states of noodles including raw, boiled, dried, fried, steamed, refrigerated, and instant noodles, water to be added to flour, water used for boiling and steaming, and water for humidifying during refrigeration has not been examined well. More specifically, it has not been examined how the water type and quality influence the product, especially in taste of noodles and cooking time of instant and dried noodles.

### SUMMARY OF THE INVENTION

It is a primary object of the present invention to improve quality of noodles and to reduce cooking time of instant and dried noodle.

In order to accomplish the aforementioned and other objects, according to a first aspect of the present invention, there is provided a method for producing noodles, comprising steps of: adding thawed snow water to flour, mixing up the flour and the thawed snow water together to make a dough, and processing the dough into strings of noodles.

The thawed snow water may be purified thawed snow water. The purified thawed snow water may be boiled prior to the adding step.

The processing step may comprise rolling the dough into a sheet fashion, and cutting the sheet into strings.

According to another aspect of the present invention, there is provided a method for producing boiled noodles, comprising steps of making raw noodles, and cooking the raw noodles in boiling thawed snow water.

The thawed snow water preferably has a half-width in the cluster analysis which is approximately one-half of that of usual water such as tap water.

The thawed snow water is soft water, and preferably has a hardness of approximately 7.3.

The aforementioned methods may further comprise a step of refrigerating the noodles by utilizing snow. The refrigerating step may comprise covering the noodles with snow. The refrigerated noodles can be processed into instant or dried noodles.

According to still another aspect of the present invention, noodles produced by any one of the above methods is provided.

According to yet another aspect of the present invention, there is provided a method for producing food, comprising steps of purifying thawed snow water, and processing food with the purified thawed snow water.

### DESCRIPTION OF THE PREFERRED EMBODIMENTS

Some preferred embodiments of the present invention will be hereinafter described in detail. The present invention utilizes thawed snow water for producing noodles. More specifically, noodles are produced by adding thawed snow water to flour, mixing them up together to make a dough, rolling the dough like a sheet, and cutting the sheet of noodles into strings. The present invention also utilizes the thawed snow water for producing boiled noodles. In other words, the boiled noodles are cooked in boiling the thawed snow water. The thawed snow water can be used without any process if the thawed snow water contains no impurities such as dirt or dust. The thawed snow water should be utilized after purification or boiling if the thawed snow water contains impurities.

Some experiments on the thawed snow water produced the following experimental results:

(1) water hardness

The thawed snow water had a hardness of 7.3, while the tap water had a hardness of 62.9. This result shows that the thawed snow water was very soft.

(2) permeability of thawed snow water

The thawed snow water was less permeable than the tap water to a small extent.

(3) mineral analysis of thawed snow water

Sodium: 0.8 ppm

Potassium: 0.5 ppm

Calcium: 0.3 ppm

Magnesium: less than the detection limit

Ferrum: less than the detection limit

Zinc: less than the detection limit

Copper: less than the detection limit

Manganese: less than the detection limit

Phosphorus: less than the detection limit

(4) Brabender test

TABLE 1
<Brabender test> flour (“Kanpaku”)

| | <thawed snow water> | | <tap water> | |
|---|---|---|---|---|
| (amylogram) | | | | |
| G.T. (gelatinization | 57.4° C. | | 56.4° C. | |
| start temperature) | | | | |
| M.V. (maximum viscosity) | 923 | B.U. | 889 | B.U. |
| M.V.T. (M.V. temperature) | 93.8° C. | | 93.5° C. | |
| (farinogram) | | | | |
| AbS (water absorption) | 60.7% | | 60.5% | |
| P.T. (peak time) | 2.3 | min. | 2.2 | min. |
| Stad | 1.8 | min. | 2.5 | min. |
| V.V. (valorimeter value) | 42 | | 42 | |
| W.K. (weakness) | 120 | B.U. | 120 | B.U. |
| (extensongram) | | | | |
| AbS (water absorption) | 58.7% | | 58.6% | |
| A (area) | 148 | cm² | 161 | cm² |
| R (resilience) | 715 | B.U. | 775 | B.U. |
| E (extensibility) | 161 | mm | 163 | mm |
| R/E | 4.44 | | 4.76 | |

The thawed snow water had a higher M.V. (maximum viscosity) in the amylogram than the tap water.

(5) cluster analysis on tap water and thawed snow water

| (sample) | (half-width (Hz)) |
|---|---|
| tap water: | 112.97 |
| thawed snow water: | 57.22 |

These results shows that the thawed snow water to be added to the flour for producing noodles and to be used for boiling noodles, has a half-width which is approximately one-half of that of usual water such as tap water. That is, the thawed snow water has a large osmotic pressure. Further, the thawed snow water is very soft water having a hardness of approximately 7.3, while the tap water has a hardness of approximately 62.9.

Moreover, according to the present invention, the noodles and the boiled noodles produced through the aforementioned methods may be refrigerated. For example, the refrigeration may be done by covering the noodles or boiled noodles with snow, or by storing the noodles or boiled noodles in an ambience where snow intervenes. After the storage, the noodles or the boiled noodles may be served in a raw fashion, or may be processed into instant noodles or dried noodles.

The noodles produced through these methods retain the following characteristics according to the thawed snow water or soft water. The characteristics cannot be derived from noodles produced with tap water or natural water.

A first characteristic is good taste of the noodles itself. Reasons for the good taste are inclusion of various minerals in the thawed snow water, softness of the thawed snow water, high viscosity, and the half-width of the cluster which is approximately one-half of that of usual water. However, a lot of uncertainty remains.

A second characteristic is reduction of the time required to cook the instant noodles, the dried noodles, or the raw noodles in boiling water. This characteristic actualizes instant spaghetti and instant thick type of udon (Japanese wheat flour noodles). Conventionally, the instant spaghetti or the instant thick udon had been considered an impossibility.

(6) results of sensory testing on udon and hiyamugi, i.e. a kind of Japanese noodles thinner than the udon, with thawed snow water

TABLE 2
sensory testing on hand-stretched udon with thawed snow water

| | | tester No. | | | | | | |
|---|---|---|---|---|---|---|---|---|
| item and point | | 1 | 2 | 3 | 4 | 5 | 6 | average |
| color | 20 | 14 | 16 | 18 | 16 | 16 | 16 | 16.0 |
| appearance, | 15 | 10.5 | 10.5 | 10.5 | 10.5 | 12 | 12 | 11.0 |
| texture | | | | | | | | |
| manducatory | | | | | | | | |
| texture | | | | | | | | |
| firmness | 10 | 9 | 8 | 9 | 8 | 7 | 8 | 8.2 |
| viscoelasticity | 25 | 25 | 20 | 22.5 | 20 | 20 | 20 | 21.3 |
| smoothness | 15 | 10.5 | 12 | 10.5 | 12 | 12 | 10.5 | 11.3 |
| taste, flavor | 15 | 10.5 | 10.5 | 10.5 | 10.5 | 12 | 12 | 11.0 |
| total | 100 | 79.5 | 77 | 81 | 77 | 79 | 78.5 | 78.7 |

TABLE 3
sensory testing on hiyamugi (raw) with thawed snow water

| | | tester No. | | | | | | |
|---|---|---|---|---|---|---|---|---|
| item and point | | 1 | 2 | 3 | 4 | 5 | 6 | average |
| color | 20 | 16 | 18 | 18 | 16 | 18 | 18 | 17.3 |
| appearance, | 15 | 12 | 10.5 | 10.5 | 10.5 | 12 | 12 | 11.3 |
| texture | | | | | | | | |
| manducatory | | | | | | | | |
| texture | | | | | | | | |
| firmness | 10 | 7 | 6 | 8 | 7 | 8 | 8 | 7.3 |
| viscoelasticity | 25 | 20 | 17.5 | 20 | 17.5 | 17.5 | 20 | 18.8 |
| smoothness | 15 | 12 | 10.5 | 10.5 | 10.5 | 10.5 | 12 | 11.0 |
| taste, flavor | 15 | 10.5 | 10.5 | 10.5 | 10.5 | 12 | 12 | 11.0 |
| total | 100 | 77.5 | 73 | 77.5 | 72 | 78 | 82 | 76.7 |

TABLE 4
sensory testing on hiyamugi (dried) with thawed snow water

| | | tester No. | | | | | | |
|---|---|---|---|---|---|---|---|---|
| | | | | | | | | ave- |
| item and point | | 1 | 2 | 3 | 4 | 5 | 6 | rage |
| color | 20 | 16 | 16 | 16 | 16 | 16 | 16 | 16.0 |
| appearance, | 15 | 10.5 | 10.5 | 10.5 | 10.5 | 12 | 10.5 | 10.8 |
| texture | | | | | | | | |
| manducatory | | | | | | | | |
| texture | | | | | | | | |
| firmness | 10 | 7 | 6 | 8 | 6 | 7 | 8 | 7.0 |
| viscoelasticity | 25 | 17.5 | 20 | 17.5 | 17.5 | 20 | 22.5 | 19.2 |
| smoothness | 15 | 10.5 | 10.5 | 10.5 | 9 | 10.5 | 12 | 10.5 |
| taste, flavor | 15 | 10.5 | 10.5 | 10.5 | 10.5 | 7.5 | 10.5 | 10.0 |
| total | 100 | 72 | 73.5 | 73 | 69.5 | 73 | 79.5 | 73.4 |

TABLE 5
general results of sensory testing on noodles
with thawed snow water

| | | evaluation | | | | | | |
|---|---|---|---|---|---|---|---|---|
| | | bad | | | | good | | |
| item and point | | much | some | little | normal | little | some | much |
| color | 20 | 8 | 10 | 12 | 14 | 16 | 18 | 20 |
| appearance, | 15 | 6 | 7.5 | 9 | 10.5 | 12 | 13.5 | 15 |
| texture | | | | | | | | |
| manducatory | | | | | | | | |
| texture | | | | | | | | |
| firmness | 10 | 4 | 5 | 6 | 7 | 8 | 9 | 10 |
| viscoelasticity | 25 | 10 | 12.5 | 15 | 17.5 | 20 | 22.5 | 25 |
| smoothness | 15 | 6 | 7.5 | 9 | 10.5 | 12 | 13.5 | 15 |
| taste, flavor | 15 | 6 | 7.5 | 9 | 10.5 | 12 | 13.5 | 15 |

The above sensory testing was made, according to a standard sensory testing method, on the basis of whether or not difference was found between noodles such as hand-stretched udon, and raw and dried hiyamugi with usual tap water and that with thawed snow water. It should be noted that the evaluation of the samples produced with the tap water was set to total 70 points which was indicated as “normal” in Table 5. More specifically, the samples produced with the thawed snow water were evaluated every item under comparison with the sample using the tap water which has 70% of point every item.

The testing indicated that each type of noodles produced with thawed snow water had a better result than the noodles produced with the tap water. The results in descending order of excellentness were as follows: hand-stretched udon, hiyamugi (raw), hiymaugi (dried). The hand-stretched udon produced with the thawed snow water especially marked an excellent result. The items on which the noodles with thawed snow water especially marked excellent results are color, manducatory firmness, and viscoelasticity. These results can actualize product differentiation and improvements in quality.

Thus, the present invention can produce the noodles having better taste, comparing with that produced with usual tap water and natural water. Moreover, the present invention can reduce the time required to cook the instant noodles, dried noodles, or raw noodles in boiling water, thereby actualizing instant spaghetti and instant thick udon, which had been considered an impossibility as mentioned above. Further, the thawed snow water, almost of which has been usually flown out into a river as drainage, can be effectively employed according to the present invention, thereby lowering the cost for producing the noodles.

The present invention can also be applied for providing water for processing food, and drinking water, as follows:

(I) Water for processing food produced by purifying thawed snow water. The water for processing food may be boiled up after the purification. Moreover, the food is defined as various kinds of foodstuffs.

(II) Drinking water produced by purifying thawed snow water. The drinking water may be boiled up after the purification in a similar way as mentioned above.

The water for processing food according to the present invention is weak-alkaline and soft, thereby improving the taste and flavor of the food processed with the thawed snow water with respect to that processed with usual water such as the tap water and the natural water. Deaerated water is often utilized as water for processing food. However, deaerator equipment necessary to produce the deaerated water is accompanied by its initial and running costs, thereby making the deaerated water expensive. On the other hand, the water for processing food according to the present invention can be produced at low cost by utilizing the thawed snow water.

The water for processing food according to the present invention is also utilized for producing boiled rice, alcoholic drinks (for example, beer, whiskey, wine, and liquor), tofu, soybean paste, soy sauce, and natto, i.e. fermented soybeans, konnyaku, bread, cake, and sweets as well as noodles (for example, udon, buckwheat noodles, Chinese noodles, and spaghetti).

The drinking water according to the present invention is weak-alkaline and soft as well as the water for processing food. These characteristics draw out better taste and flavor of the drinking water. Further, the drinking water is smooth and free from peculiarity. Moreover, the drinking water exhibits good absorption.

Furthermore, the present invention may be applied for cooking, tea, coffee, ice, industrial purposes, and cosmetics.

While the presently preferred embodiments of the present invention have been shown and described, it is to be understood that these disclosures are for the purpose of illustration and that various changes and modifications may be made without departing from the scope of the invention as set forth in the appended claim.

What is claimed is:

1. A method for producing noodles, comprising steps of:
adding thawed snow water to flour;
mixing up the flour and the thawed snow water together to make a dough; and
processing the dough into strings of noodles.

2. The method according to claim 1, wherein the processing step comprises rolling the dough into a sheet, and cutting the sheet into strings.

3. The method according to claim 1, wherein the thawed snow water is purified before adding the water to the flour.

4. The method according to claim 1, wherein the purified thawed snow water is boiled before adding the water to the flour.

5. The method according to claim 1, wherein the thawed snow water has a half-width in a cluster analysis which is approximately one-half of that of usual water.

6. The method according to claim 1, wherein the thawed snow water is soft water.

7. The method according to claim 6, wherein the soft water has a hardness of approximately 7.3.

8. The method according to claim 1, further comprising a step of refrigerating the noodles by utilizing snow.

9. The method according to claim 8, wherein the refrigerating step comprises covering the noodles with snow.

10. The method according to claim 8, further comprising a step of processing the refrigerated noodles into instant noodles.

11. The method according to claim 8, further comprising a step of processing the refrigerated noodles into dried noodles.

12. A method for producing boiled noodles, comprising steps of:
making raw noodles; and
cooking the raw noodles in boiling thawed snow water.

13. The method according to claim 12, wherein the thawed snow water is purified before boiling.

14. The method according to claim 12, wherein the thawed snow water has a half-width in a cluster analysis which is approximately one-half of that of usual water.

15. The method according to claim 12, wherein the thawed snow water is soft water.

16. The method according to claim 15, wherein the soft water has a hardness of approximately 7.3.

17. The method according to claim 12, further comprising a step of refrigerating the noodles by utilizing snow.

18. The method according to claim 17, wherein the refrigerating step comprises covering the noodles with snow.

19. The method according to claim 17, further comprising a step of processing the refrigerated noodles into instant noodles.

20. The method according to claim 17, further comprising a step of processing the refrigerated noodles into dried noodles.

21. Noodles produced by one of the methods according to 1-20.

22. A method for producing food, comprising steps of:
purifying thawed snow water; and
processing food with the purified thawed snow water.

23. The method according to claim 22, further comprising a step of boiling the purified thawed snow water subsequent to the purifying step.

24. The method according to claim 22, wherein the food is any one of boiled rice, alcoholic drinks, tofu, soybean paste, soy sauce, bread, and cake.
